(19) United States
(12) Patent Application Publication
(10) Pub. No.: US 2014/0282463 A1
(43) Pub. Date: Sep. 18, 2014

(54) Concurrent Patching of Shared Libraries

(71) Applicant: Stephen B. Peckham, Austin, TX (US)

(72) Inventor: Stephen B. Peckham, Austin, TX (US)

(73) Assignee: INTERNATIONAL BUSINESS MACHINES CORPORATION, Armonk, NY (US)

(21) Appl. No.: 14/040,825

(22) Filed: Sep. 30, 2013

Related U.S. Application Data
(63) Continuation of application No. 13/844,345, filed on Mar. 15, 2013.

(51) Int. Cl. G06F 9/445

(52) U.S. Cl. CPC G06F 8/67
USPC 717/168

(57) ABSTRACT

Provided are techniques for generating a patch corresponding to a shared library; determining that the patch fits within the shared library; generating a signature corresponding to the shared library and an offset corresponding to the patch; identifying an instantiation of the shared library stored in a memory; and overlying the patch in the instantiation at a position corresponding to the offset.

### CROSS-REFERENCES TO RELATED APPLICATIONS

The present application is a continuation and claims the benefit of the filing date of an application titled, “Concurrent Patching of Shared Libraries” Ser. No. 13/844,345, filed Mar. 15, 2013, assigned to the assignee of the present application and herein incorporated by reference.

### FIELD OF DISCLOSURE

The claimed subject matter relates generally to computing systems and, more specifically, to techniques for the modification of shared libraries without shutting down associated programs.

### BACKGROUND OF THE INVENTION

Most operating systems (OSs) provide for the implementation of shared libraries, which may also be known, among other names, as shared or dynamically-linked objects. In a typical OS, shared libraries in need of a repair, or patch, are fixed by replacing one version with another. However, programs that are currently running continue to use the original rather than the replacement, or new, version and only newly executed programs access the new version. This scenario implies that a running program must be restarted to take advantage of an OS modification and, if the running program is a system service that cannot be stopped and restarted, the entire computing system must be rebooted.

### SUMMARY

Provided are techniques for an OS to be modified on a running system such that running programs, including system services, so not have to be stopped and restarted for the modification to take effect.

Provided are techniques for generating a patch corresponding to a shared library; determining that the patch fits within the shared library; generating a signature corresponding to the shared library and an offset corresponding to the patch; identifying an instantiation of the shared library stored in a memory; and overlying the patch in the instantiation at a position corresponding to the offset.

This summary is not intended as a comprehensive description of the claimed subject matter but, rather, is intended to provide a brief overview of some of the functionality associated therewith. Other systems, methods, functionality, features and advantages of the claimed subject matter will be or will become apparent to one with skill in the art upon examination of the following figures and detailed description.

### BRIEF DESCRIPTION OF THE DRAWINGS

A better understanding of the claimed subject matter can be obtained when the following detailed description of the disclosed embodiments is considered in conjunction with the following figures, in which:

FIG. 1 is a block diagram of a computing system architecture that may implement the claimed subject matter.

FIG. 2 is a block diagram of a computing system, first introduced in FIG. 1, in greater detail.

FIG. 3 is a flowchart of a “Modify Library” process that may implement aspect of the claimed subject matter.

FIG. 4 is a flowchart of an “Install Patch” process that may implement aspect of the claimed subject matter.

### DETAILED DESCRIPTION

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational actions to be performed on the computer, other programmable apparatus or other devices to produce a computer implemented process such that the instructions which execute on the computer or other programmable apparatus provide processes for implementing the functions/acts specified in the flowchart and/or block diagram block or blocks.

Turning now to the figures, FIG. 1 is a block diagram of a computing system architecture 100 that may implement the claimed subject matter. A computing system 102 includes a central processing unit (CPU) 104, coupled to a display 106, a keyboard 108 and a pointing device, or “mouse,” 110, which together facilitate human interaction with elements of architecture 100 and computing system 102. Also included in computing system 102 and attached to CPU 104 is a computer-readable storage medium (CRSM) 112, which may either be incorporated into client system 102 i.e. an internal device, or attached externally to CPU 104 by means of various, commonly available connection devices such as but not limited to, a universal serial bus (USB) port (not shown). CRSM 112 is illustrated storing an operating system (OS) 114, which incorporates the claimed subject matter, and an example of a computer software program, or simply “program,” 116, which is modified in accordance with the claimed subject matter. Components 114 and 116 are described in more detail below in conjunction with FIGS. 2-4.

Client system 102 and CPU 104 are connected to the Internet 120, which is also connected to a server computer, or simply “server,” 122. Although in this example, client system 102 and server 122 are communicatively coupled via the Internet 120, they could also be coupled through any number of communication mediums such as, but not limited to, a local area network (LAN) (not shown). In the following description, server 122 is used as an example of a computing device from which a patch generated and installed in accordance with the claimed subject matter may originate. Further, it should be noted there are many possible configurations of computing system architectures and computing systems that may implement the claimed subject matter, of which architecture 100 and computing system 102 are only simple examples.

FIG. 2 is a block diagram of computing system 102, first introduced in FIG. 1, in greater detail. As shown in FIG. 1, computing system 102 is illustrated in the form of a general-purpose computing device. In this example, components of computing system 102 include, but are not limited to, CPU 104 (FIG. 1), which may include one or more processors (not shown), a system bus 132, which couples various components to CPU 104, including but not limited to, input/output (I/O) interfaces 134, a network interface card (NIC) 136 and memory 140. In this example, NIC 136 may provide a communication path between computing system 102 and the Internet 120 (FIG. 1) and may also provide a connection to a LAN (not shown) or other network. I/O interfaces 134 enable various components (FIG. 1) to be coupled to computing system 102 such as display 106 (FIG. 1) and external devices 138. In this example, external devices 138 may include keyboard 108 (FIG. 1) and mouse 110 (FIG. 1).

Bus 132 represents one or more of any of several types of bus structures, which for the sake of simplicity are not shown, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Memory 140 typically includes a variety of computer system readable media. Such media may be any available media that is accessible by computer system/server 102 and includes both volatile and non-volatile media. In this example, memory 140 includes CRSM 112 (FIG. 1), random access memory (RAM) 142 and cache memory, or simply “cache,” 144. RAM 142 is also illustrated storing a shared library 143, which is modified in accordance with the claimed subject matter. It should be understood that RAM 142 may typically include multiple shared libraries but for the sake of simplicity only one is shown. In addition, SL 143 may be stored in multiple locations in memory 140. For example, in some cases, applications such as program 116 may utilize private copies of shared libraries rather than an instantiation that is shared by multiple applications.

Computing system 102 and memory 140 may also further include other volatile/non-volatile computer system storage media. Memory 140 is also illustrated storing program 116 (FIG. 1), which includes one or more program modules 146 that are configured to carry out the functions of program 116. Program 116 and program modules 146, may be stored in one or more locations in memory 140, including CRSM 112, RAM 142 and cache 144.

FIG. 3 is a flowchart of a “Modify Library” process 200 that may implement aspect of the claimed subject matter. Although aspects of process 200 may be automated, i.e. performed by logic stored in a memory and executed on a processor, aspects of process 200 may also be performed manually. Process 200 starts in a “Modify Library” block 202 and proceeds immediately top an “Examine Code” block 204. During processing associated with block 204, a shared library, which in the example will be SL 143 (FIG. 2), is examined, typically by reviewing by looking at compiler listings. Information that is relevant to the claimed subject matter includes both executable and non-executable areas of the code. Non-executable areas of code may include, but are not limited to, function names and comments.

During processing associated with an “Identify Code to be Modified” block 206, SL 143 is examined to identify the particular area or areas that are to be modified. During processing associated with a “Generate Replacement Code” block 208, new or modified, replacement code is generated for the particular area or areas identified during processing associated with block 206. The replacement code is typically generated with the assistance of a compiler or assembler.

During processing associated with a “Calculate Available Space” block 210, the size, or memory required to load the replacement code generated during processing associated with block 208 is compared to the size of the code identified to be modified plus any other memory currently storing non-executable information, both of which were identified during processing associated with block 206. During processing associated an “Enough Space?” block 212, a determination is made as to whether or not the replacement code is small enough to be stored in the available space calculated during processing associated with block 210. If not, control proceeds to a “Transmit Notice” block during which the user or administrator who initiated process 200 is notified that there is insufficient memory available to implement the code replacement in accordance with the disclosed technology.

If, during processing associated with block 212, a determination is made that enough space is available, control proceed to a “Specify Address and Offset” block 216. During processing associated with block 216, a signature associated with SL 143 is created that so any instantiations of SL 143 in memory 140 may be identified (see 254, FIG. 4). An offset identifies where in SL 143 the code generated during processing associated with block 208 is to be overlaid (see 262, FIG. 4). It should be understood that multiple sections of replacement code may be overlaid, each with a corresponding offset. In other words, there is no requirement that replacement code must be stored in contiguous locations within SL 143.

During processing associated with a “Transmit Patch” block 218, the replacement code generated during processing associated with block 208 in conjunction with the signature and offset information generated during processing associated with block 216 are transmitted to a process that is responsible for installing the modified code (see 250, FIG. 4). Finally, once the code has been transmitted during processing associated with block 218 or note has been transmitted during processing associated with block 214, control proceeds to an “End Modify Code” block 219 in which process 200 is complete.

FIG. 4 is a flowchart of a “Install Patch” process 250 that may implement aspect of the claimed subject matter. Unlike process 200 (FIG. 3), process 250 is typically not done manually. In this example, logic associated with process 250 is stored in CRSM 112 (FIGS. 1 and 2) and executed on one or more processors (not shown) of CPU 104 (FIGS. 1 and 2) of computing system 102 (FIGS. 1 and 2).

Process 250 starts in a “Begin Install Patch” block 252 and proceeds immediately to a “Receive Patch” block 254. During processing associated with block 254, a library code modification, or “patch,” is received by process 250 (see 218, FIG. 3). During processing associated with a “Search Libraries” block 254, memory 140 is searched for instantiations of, in this example, SL 143. Instantiations of SL 143 are identified by the presence of a matching signature (see 216, FIG. 3). As explained above in conjunction with FIG. 2, copies of SL 143 may be stored in multiple locations in memory 140 (FIG. 2). For example program 116 (FIGS. 1 and 2) may include a private copy of SL 143 and copies may be stored on CRSM 112.

During processing associated with a “Code Found?” block 256, a determination is made as to whether or not an instances of SL 143 have been located in memory 140. If not, control proceeds to a “Transmit Notice” block 258 during which the user who initiated process 250 is notified that no shared libraries matching SL 143 have been located. If instances are found, control proceeds to a “Select Next Instance” block 260. During processing associated with block 260, one of the instances located during processing associated with block 254 is selected for processing. During processing associated with a “Write Instructions” block 262, the patch generated during processing associated with block 208 (FIG. 3) is overlaid in the instantiation selected during processing associated with block 260 based upon the position indicated by the offset generated during processing associated with block 216 (FIG. 3). It should be noted sections of a particular patch may be overlaid in corresponding positions based upon multiple offsets.

During processing associated with a “More Instances?” block 264, a determination is made as to whether or not there are additional instances of SL 143 that were located during processing associated with block 254. If so, control returns to block 260, a unprocessed instance to SL 143 is selected and processing continues as described above. If a determination is made that there are no more instances of SL 143 to be processed or, if during processing associated with block 258, a notice has been transmitted, control proceeds to an “End Install Patch” block 269 in which process 250 is complete.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

We claim:

1. A method, comprising:
generating a patch corresponding to a shared library;
determining that the patch fits within the shared library;
generating a signature corresponding to the shared library and an offset corresponding to the patch;
identifying an instantiation of the shared library stored in a memory; and
overlying the patch in the instantiation at a position corresponding to the offset.

2. The method of claim 1, further comprising:
identifying a plurality of memory regions within the shared library that do not store executable code; and
overlaying the patch within the instantiation in locations that correspond to the plurality of memory regions.

3. The method of claim 1, the determining comprising:
identifying code within the share library that is to be overlaid by the patch;
comparing the size of the patch with the size of the identified code within the shared library; and
in response to a determination that the size of the patch is not greater than the size of the identified code, determine that the patch fits within the shared library.

4. The method of claim 1, the determining comprising:
identifying code within the shared library that is to be overlaid by the patch;
identifying a region of the shared library that is non-executable;
comparing the size of the patch with the size of the identified code within the shared library plus the size of the region that is non-executable; and
in response to a determination that the size of the patch is not greater than the size of the identified code plus the non-executable region, determine that the patch fits within the shared library.

5. The method of claim 1, wherein the patch is overlaid in the instantiation without rebooting the system on which the shared library is installed.

6. The method of claim 1, wherein the patch is overlaid while a program that employs the instantiation remains running.
